(19) United States
(12) Patent Application Publication
(10) Pub. No.: US 2024/0149494 A1
(43) Pub. Date: May 9, 2024

(54) APPARATUS AND METHOD FOR SILICON CARBIDE INGOT PEELING

(71) Applicant: Industrial Technology Research Institute, Hsinchu (TW)

(72) Inventors: WENG-JUNG LU, Hsinchu City (TW); YING-FANG CHANG, Hsinchu City (TW); PIN-YAO LEE, Hsinchu County (TW); YI-WEI LIN, Taichung City (TW)

(21) Appl. No.: 18/109,077

(22) Filed: Feb. 13, 2023

(30) Foreign Application Priority Data
Nov. 7, 2022 (TW) 111142404

(51) Int. Cl. B28D 5/00

(52) U.S. Cl. CPC B28D 5/0011; B28D 5/0052; B23K 26/53

(57) ABSTRACT

A method for silicon carbide ingot peeling includes the steps of: placing the silicon carbide ingot between first and second suckers; having a pressing head disposed on a top surface of the first sucker to apply mechanical oscillatory energy to both the silicon carbide ingot and the second sucker through the first sucker; and, having an elastic element disposed under the second sucker to absorb part of the mechanical oscillatory energy to transmit longitudinal waves thereof to a modified layer of the silicon carbide ingot for propagating individually intermittent invisible cracks at the modified layer to break silicon carbide chains at different levels. Till the cracks connect together for forming a continuous crack across the silicon carbide ingot, a top portion of the silicon carbide ingot is then separable therefrom to form a wafer. In addition, an apparatus for silicon carbide ingot peeling is also provided.

### CROSS REFERENCE TO RELATED APPLICATION

This application claims the benefits of Taiwan application Serial No. 111142404, filed on Nov. 7, 2022, the disclosures of which are incorporated by references herein in its entirety.

### TECHNICAL FIELD

The present disclosure relates in general to a wafer technology, and more particularly to an apparatus and a method for silicon carbide ingot peeling that utilize high frequency energy.

### BACKGROUND

In a typical semiconductor manufacturing process, a step of “separating a wafer from a silicon carbide ingot” is included, which is also referred to as a step of “peeling” or “splitting”. In a typical peeling step, a breaker is utilized to separate the wafer from a silicon carbide ingot that has intermittent invisible cracks at a laser modified layer.

Conventionally, a typical breaker is to provide a wet process. In this wet process, a silicon carbide ingot is placed in a liquid (such as water) with a specific temperature. Through a sonotrode energy placed above or below the silicon carbide ingot, a sonic vibration frequency can be applied to separate a wafer from a laser modified layer via using the water as the medium.

The above-mentioned conventional separating or peeling method is associated with various shortcomings such as a high material loss, a slow cutting speed and a coarse wafer surface, and thus subsequent surface processing and grinding are required.

In addition, in order to maintain the specific temperature of the liquid, a temperature control equipment must be installed. However, such a move would complicate the equipment of the wet-type breaker, and inevitably the maintenance cost thereof would be high.

Accordingly, the issue how to provide an apparatus and a method for silicon carbide ingot peeling that can use high-frequency energy beams to assist the separation or peeling of the silicon carbide ingot and thus to improve surface roughness of a cutting surface at the silicon carbide ingot, such that the cutting loss in peeling the silicon carbide ingot can be reduced, the yield and efficiency thereof can be enhanced, and the cutting and grinding time and cost thereto can be reduced, is definitely an urgent problem to be solved by people in the art.

### SUMMARY

In one embodiment of this disclosure, an apparatus for silicon carbide ingot peeling, applied to the silicon carbide ingot having intermittent invisible cracks, comprises:
a first sucker, disposed at a top surface of the silicon carbide ingot, applied to provide suction to the top surface of the silicon carbide ingot;
a second sucker, disposed at a bottom surface of the silicon carbide ingot, applied to provide another suction to the bottom surface of the silicon carbide ingot;
a pressing head, disposed on a top surface of the first sucker, being to apply a mechanical oscillatory energy to the silicon carbide ingot and the second sucker through the first sucker; and
an elastic element, disposed under the second sucker, being to absorb part of the mechanical oscillatory energy.

In one embodiment of this disclosure, a method for silicon carbide ingot peeling comprises the steps of:
placing the silicon carbide ingot having intermittent invisible cracks between a first sucker and a second sucker, for the first sucker and the second sucker individually to provide corresponding suction to a top surface and a bottom surface of the silicon carbide ingot, respectively;
having a pressing head disposed on a top surface of the first sucker to apply mechanical oscillatory energy to both the silicon carbide ingot and the second sucker through the first sucker; and
having an elastic element disposed under the second sucker to absorb part of the mechanical oscillatory energy to transmit longitudinal waves of the mechanical oscillatory energy to a modified layer of the silicon carbide ingot through the top surface thereof for propagating individually the intermittent invisible cracks at the modified layer thereinside so as to break corresponding silicon carbide chains at different levels;
wherein, till the intermittent invisible cracks are extended to connect together for forming a continuous elongated crack across the silicon carbide ingot, a corresponding top portion of the silicon carbide ingot is then separable from the silicon carbide ingot to form a wafer.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic view of an embodiment of the apparatus for silicon carbide ingot peeling in accordance with this disclosure;

FIG. 2 shows schematically a work state of FIG. 1;

FIG. 3 shows schematically variations of stress with respect to time in accordance with this disclosure;

FIG. 4 is a schematic flowchart of an embodiment of the method for silicon carbide ingot peeling in accordance with this disclosure; and

FIG. 5A to FIG. 5D demonstrate schematically propagation of cracks to break silicon carbide chains at a silicon carbide ingot by applying the apparatus and method for silicon carbide ingot peeling in accordance with this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

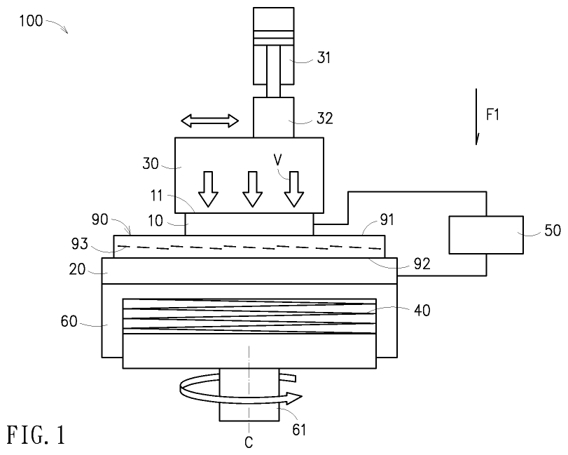

Referring to FIG. 1, an apparatus for silicon carbide ingot peeling 100 includes a first sucker 10, a second sucker 20, a pressing head 30 and an elastic element 40.

The apparatus for silicon carbide ingot peeling 100 is applicable to a silicon carbide ingot 90 having intermittent invisible cracks. In this embodiment, the cracks may be formed after a laser modification process.

The first sucker 10 is disposed on a top surface 91 of a silicon carbide ingot 90 to provide suction in between with the top surface 91 of the silicon carbide ingot 90.

The suction of the first sucker 10 provided to the top surface 91 of the silicon carbide ingot 90 can be one of vacuum suction, pressure suction and air-curtain suction.

The second sucker 20 is disposed on a bottom surface 92 of the silicon carbide ingot 90 to provide suction in between with the bottom surface 92 of the silicon carbide ingot 90.

The suction of the second sucker 20 provided to the bottom surface 92 of the silicon carbide ingot 90 can vacuum suction.

The first sucker 10 and the second sucker 20 are individually connected with a controller 50 for the controller 50 to programmably control the first sucker 10 and the second sucker 20 to provide individually the same or different suction to the top surface 91 and the bottom surface 92 of the silicon carbide ingot 90, respectively.

Materials for the first sucker 10 and the second sucker 20 of this embodiment are not limited, and can be porous ceramics or metals.

The second sucker 20 is disposed on a platform 60. The platform 60, connected with a rotational drive device 61, is driven by the rotational drive device 61 to have the platform 60 and the second sucker 20 to rotate about an axis C.

The rotational drive device 61 can be a gear, a rack, a belt, a screw bar or any drive component driven mechanically or hydraulically or driven electronically or electrically.

The pressing head 30, disposed on a top surface 11 of the first sucker 10, is connected with a transducer 31 for the transducer 31 to convert electric energy into corresponding mechanical oscillatory energy. The pressing head 30 applies the mechanical oscillatory energy V to the silicon carbide ingot 90 and the second sucker through the first sucker 10 in a relevant pressure form. The mechanical oscillatory energy V are separately applied to the silicon carbide ingot 90 in the same direction parallel to the axis C, i.e., a first direction F1 shown in FIG. 1.

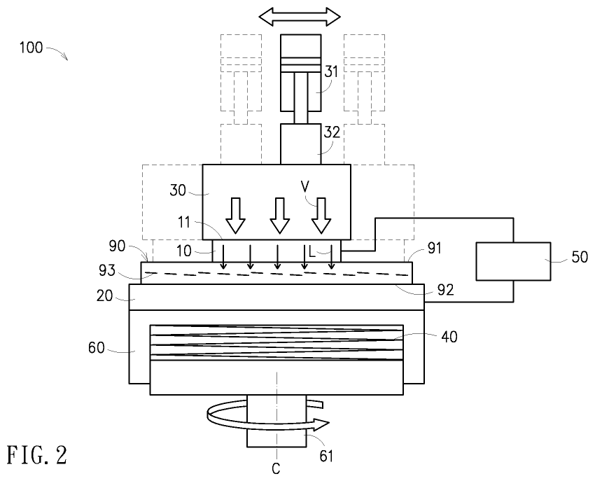

The pressing head 30, connected with a linear drive device 32, is driven by the linear drive device 32 to further drive the pressing head 30 and the first sucker 10 to undergo a linear movement (along the double arrow clipart vector shown in FIG. 1 or FIG. 2), such that the position of the silicon carbide ingot 90 can be varied by the mechanical oscillatory energy V.

The elastic element 40, disposed at the platform 60 under the second sucker 20, is applied to absorb part of the mechanical oscillatory energy V.

In this embodiment, the elastic element 40 can be a deformable element with elastic resilience such as one of a spring, a rubber and a silicone.

Referring to FIG. 2, in this embodiment, the modified silicon carbide ingot 90 having the intermittent invisible cracks 93 is firstly placed between the first sucker 10 and the second sucker 20, for the first sucker 10 and the second sucker 20 to individually apply corresponding suction to the top surface 91 and the bottom surface 92 of the silicon carbide ingot 90, respectively.

The pressing head 30 disposed on the top surface 11 of the first sucker 10 would apply the mechanical oscillatory energy V to the silicon carbide ingot 90 and the second sucker 20 via the first sucker 10.

The elastic element 40 disposed under the second sucker 20 absorbs part of the mechanical oscillatory energy V, such that longitudinal waves L of the mechanical oscillatory energy V can be transmitted to surfaces of the silicon carbide ingot 90, then deep into a modified layer of the silicon carbide ingot 90 to extend the cracks 93 therein for breaking silicon carbide chains at different levels, such that a raw wafer can be split or peeled off. Then, the first sucker 10 is applied to suck this split wafer away from the silicon carbide ingot 90.

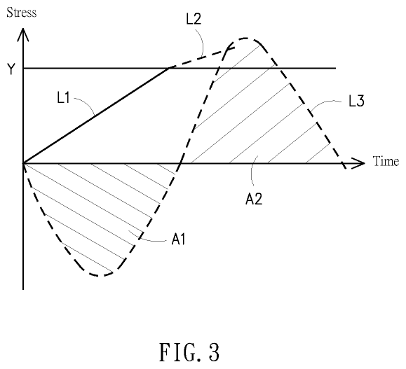

Referring to FIG. 3, the solid curve L1 therein is the stress variation at the defective elastic crack, the dashed curve L2 is the stress variation at the defective plastic crack, the curve L3 is the stress variation applied by the mechanical oscillatory energy, the area A1 is a compression area, and the area A2 is a tension area.

Referring to FIG. 2 and FIG. 3, as the longitudinal waves L of the mechanical oscillatory energy V are transmitted into the modified layer of the silicon carbide ingot 90 through the surface of the silicon carbide ingot 90, where the modified layer has the cracks 93. The silicon carbide ingot 90 at the defective elastic cracks would sustain the stress represented by the curve L1. When any of these stresses at the defective elastic cracks reaches a critical stress Y, i.e., the stress at the corresponding defective plastic crack represented by the curve L2. At this time, the corresponding cracks 93 would be extended to break the silicon carbide chains at different levels. Thereupon, a raw wafer can be generated and peeled away from the silicon carbide ingot 90.

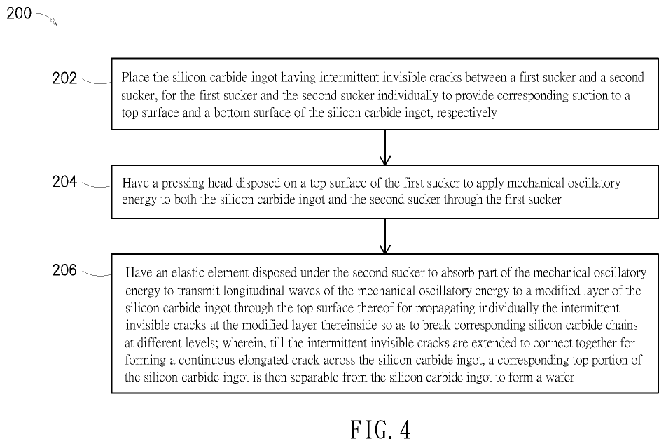

Referring to FIG. 4, the flowchart 200 of the method for silicon carbide ingot peeling in accordance with this disclosure includes the following steps.

Step 202: Place the silicon carbide ingot having intermittent invisible cracks between the first sucker and the second sucker, for the first sucker and the second sucker individually to provide corresponding suction to the top surface and the bottom surface of the silicon carbide ingot, respectively.

Step 204: The pressing head disposed on the top surface of the first sucker is utilized to apply the mechanical oscillatory energy to both the silicon carbide ingot and the second sucker through the first sucker.

Step 206: The elastic element disposed under the second sucker is utilized to absorb part of the mechanical oscillatory energy, so as to transmit the longitudinal waves of the mechanical oscillatory energy to the modified layer of the silicon carbide ingot through the surface thereof. Thereupon, the cracks at the modified layer would extend or propagate sufficiently to break the corresponding silicon carbide chains at different levels. Till the cracks are extended to connect together for forming a continuous elongated crack across the silicon carbide ingot, the corresponding top portion of the silicon carbide ingot would be separable from the silicon carbide ingot so as to form the raw wafer.

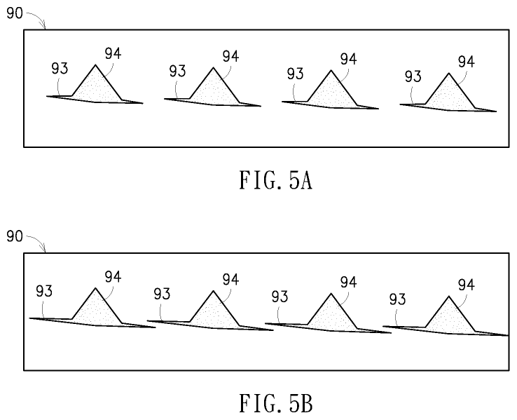

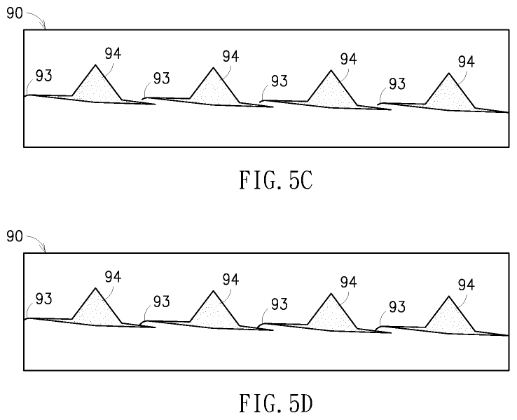

Referring to FIG. 5A through FIG. 5D, consequent steps of an application of the apparatus and method for silicon carbide ingot peeling upon the silicon carbide ingot to extend the cracks so as to break the silicon carbide chains at different levels for generating the wafer are shown schematically.

In FIG. 5A, it is shown that the silicon carbide ingot 90 has a plurality of cracks 93 (at enlarged views), in which the triangular conical laser modified layers 94 are located at top middle portions of the corresponding longitudinal cracks 93.

FIG. 5B illustrates schematically that, after the longitudinal waves L of the mechanical oscillatory energy V (see FIG. 2) are applied to the silicon carbide ingot 90, the cracks 93 would extend to two opposite sides.

FIG. 5C illustrates schematically that, after the longitudinal waves L are continuously applied to the silicon carbide ingot 90, the cracks 93 would be extended further.

FIG. 5D illustrates schematically that the cracks 93 in the silicon carbide ingot 90 would keep extending and finally connect together to form a connected cracking line for producing a wafer by splitting.

In this disclosure, major parameters can be determined through experimental modelling. These parameters for reciprocally simulations can include, for example, a thickness of the silicon carbide ingot, a cutting depth, a crack length, crack spacing, crack overlapping and spacing between laser modification boundaries. In particular, the thickness of the silicon carbide ingot can be within 365 μm to 40 mm, and the pressure of the pressing head applied on the silicon carbide ingot can be within 0.1 MPa to 0.7 Mpa.

It is found that, through applying periodical pressures at relevant frequencies upon dispersed cracks at a lower boundary of the modified layer in the silicon carbide ingot, the cracks would propagate eventually and individually along corresponding lattice planes at the lower boundary of the modified layer of the silicon carbide ingot, and finally these intermittent cracks would gradually grow and expand to connect together so as to form a connected and elongated crack vulnerable to be split therealong from the silicon carbide ingot.

It shall be explained that, in this disclosure, the elastic element is utilized to absorb part of the mechanical oscillatory energy, such that periodical energy beams at relevant frequencies can be provided onto the entire front surface of the silicon carbide ingot. Thereupon, the cracks at different levels can propagate individually and finally connect together by breaking the respective silicon carbide chains, and thus a raw wafer can be split or peeled from the silicon carbide ingot.

In addition, in this disclosure, the first sucker and the second sucker are respectively disposed to the opposite top and bottom surfaces of the silicon carbide ingot for clamping or fixing the silicon carbide ingot. Through these two suckers to connect the controller, the controller can thus programmably control the first sucker and the second sucker to provide suction to the top and bottom surfaces of the silicon carbide ingot, respectively. Thereupon, while the interconnected silicon carbide chains are broken, the first sucker would be controlled to lift the wafer smoothly up from the silicon carbide ingot. Depending on different manufacturing processes, the suction of the first sucker and the second sucker applied respectively to the top and bottom surfaces of the silicon carbide ingot might be identical or different, but programmed by the controller.

The technical features of this disclosure are obviously different from the conventional split technology of silicon carbide ingot. For example, the silicon carbide ingot is placed on top of the sonotrode by gluing with a UV glue or an epoxy adhesive, and this combination is then immersed into water for oscillations. Alternatively, in the prior art, the silicon carbide ingot is disposed under the sonotrode, and an ultrasonic treatment is performed through a water layer. Further alternatively, in the prior art, the silicon carbide ingot is also disposed under the sonotrode, but a two-step two-frequency ultrasonic treatment is performed upon the silicon carbide ingot through a water layer.

To sum up, in the apparatus and method for silicon carbide ingot peeling provided in this disclosure, high-frequency energy beams to introduced to assist the splitting of the raw wafer. Associated technical features with this disclosure include: using a high-frequency vibrator to laser modify the silicon carbide ingot, controlling the pressure head to apply micro-mechanical vibration through the upper and lower porous suckers and the pressure-controlled device for limiting the applications, using the elastic element and the platform to filter the one-way invalid vibration so as to have the layer having the intermittent invisible cracks to sustain the maximum tensile stress, and then applying periodical pressures at appropriate frequencies to transmit the longitudinal wave through the surface of the silicon carbide ingot into the modified layer of the silicon carbide ingot so as to propagate the cracks through fatiguing the material and finally to break the interconnected silicon carbide chains at different planes levels, such that a raw wafer can be split and peeled off from the silicon carbide ingot smoothly.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An apparatus for silicon carbide ingot peeling, applied to the silicon carbide ingot having intermittent invisible cracks, comprising:
a first sucker, disposed at a top surface of the silicon carbide ingot, applied to provide suction to the top surface of the silicon carbide ingot;
a second sucker, disposed at a bottom surface of the silicon carbide ingot, applied to provide another suction to the bottom surface of the silicon carbide ingot;
a pressing head, disposed on a top surface of the first sucker, being to apply a mechanical oscillatory energy to the silicon carbide ingot and the second sucker through the first sucker; and
an elastic element, disposed under the second sucker, being to absorb part of the mechanical oscillatory energy.

2. The apparatus for silicon carbide ingot peeling of claim 1, wherein the pressing head is connected with a transducer for converting an electric energy into the mechanical oscillatory energy.

3. The apparatus for silicon carbide ingot peeling of claim 1, wherein the suction that the first sucker applies to the top surface of the silicon carbide ingot is one of vacuum suction, pressure suction and air-curtain suction.

4. The apparatus for silicon carbide ingot peeling of claim 1, wherein the suction that the second sucker applies to the bottom surface of the silicon carbide ingot is vacuum suction.

5. The apparatus for silicon carbide ingot peeling of claim 1, wherein the pressing head is connected with a linear drive device, for the linear drive device to drive the pressing head and the first sucker to undergo linear movements.

6. The apparatus for silicon carbide ingot peeling of claim 1, wherein the second sucker is disposed on a platform.

7. The apparatus for silicon carbide ingot peeling of claim 6, wherein the platform is connected with a rotational drive device, for the rotational drive device to drive the platform and the second sucker to rotate about an axis parallel to a direction that the mechanical oscillatory energy is applied to the silicon carbide ingot.

8. The apparatus for silicon carbide ingot peeling of claim 6, wherein the elastic element is disposed at the platform and under the second sucker.

9. The apparatus for silicon carbide ingot peeling of claim 1, wherein the first sucker and the second sucker are individually connected with a controller, for the controller to programmably control the first sucker and the second sucker to apply identical or different suction to the top surface and the bottom surface of the silicon carbide ingot, respectively.

10. The apparatus for silicon carbide ingot peeling of claim 1, wherein the first sucker and the second sucker are made of porous ceramics or metals.

11. A method for silicon carbide ingot peeling, comprising the steps of:
placing the silicon carbide ingot having intermittent invisible cracks between a first sucker and a second sucker, for the first sucker and the second sucker individually to provide corresponding suction to a top surface and a bottom surface of the silicon carbide ingot, respectively;
having a pressing head disposed on a top surface of the first sucker to apply mechanical oscillatory energy to both the silicon carbide ingot and the second sucker through the first sucker; and
having an elastic element disposed under the second sucker to absorb part of the mechanical oscillatory energy to transmit longitudinal waves of the mechanical oscillatory energy to a modified layer of the silicon carbide ingot through the top surface thereof for propagating individually the intermittent invisible cracks at the modified layer thereinside so as to break corresponding silicon carbide chains at different levels;
wherein, till the intermittent invisible cracks are extended to connect together for forming a continuous elongated crack across the silicon carbide ingot, a corresponding top portion of the silicon carbide ingot is then separable from the silicon carbide ingot to form a wafer.

12. The method for silicon carbide ingot peeling of claim 11, wherein the pressing head is connected with a transducer for converting an electric energy into the mechanical oscillatory energy.

13. The method for silicon carbide ingot peeling of claim 11, wherein the suction that the first sucker applies to the top surface of the silicon carbide ingot is one of vacuum suction, pressure suction and air-curtain suction.

14. The method for silicon carbide ingot peeling of claim 11, wherein the suction that the second sucker applies to the bottom surface of the silicon carbide ingot is vacuum suction.

15. The method for silicon carbide ingot peeling of claim 11, wherein the pressing head is connected with a linear drive device, for the linear drive device to drive the pressing head and the first sucker to undergo linear movements.

16. The method for silicon carbide ingot peeling of claim 11, wherein the second sucker is disposed on a platform.

17. The method for silicon carbide ingot peeling of claim 16, wherein the platform is connected with a rotational drive device, for the rotational drive device to drive the platform and the second sucker to rotate about an axis parallel to a direction that the mechanical oscillatory energy is applied to the silicon carbide ingot.

18. The method for silicon carbide ingot peeling of claim 16, wherein the elastic element is disposed at the platform and under the second sucker.

19. The method for silicon carbide ingot peeling of claim 11, wherein the first sucker and the second sucker are individually connected with a controller, for the controller to programmably control the first sucker and the second sucker to apply identical or different suction to the top surface and the bottom surface of the silicon carbide ingot, respectively.

20. The method for silicon carbide ingot peeling of claim 11, wherein the first sucker and the second sucker are made of porous ceramics or metals.
